(19) United States
(12) Patent Application Publication
(10) Pub. No.: US 2009/0311473 A1
(43) Pub. Date: Dec. 17, 2009

(54) HEAT-ACTIVATEDLY BONDABLE 2D DIECUTTING ELEMENT

(75) Inventors: Marc Husemann, Hamburg (DE); Maren Kampers, Seevetal (DE)

Correspondence Address: NORRIS, MCLAUGHLIN & MARCUS, P.A., 875 THIRD AVE, 18TH FLOOR, NEW YORK, NY, 10022, US

(73) Assignee: TESA AG, Hamburg (DE)

(21) Appl. No.: 12/375,738

(22) PCT Filed: Aug. 8, 2007
(86) PCT No.: PCT/EP07/58223

§ 371 Date: Mar. 16, 2009

(30) Foreign Application Priority Data
Sep. 8, 2006 (DE) 102006042816.1

(51) Int. Cl. C09J 7/02; B32B 3/10; B05D 5/10

(52) U.S. Cl. 428/137; 427/208

(57) ABSTRACT

A heat-activatedly bondable, substantially two-dimensional (“2D”) diecutting element having a carrier, a first adhesive coating and a second adhesive coating is presented, its carrier taking the form of a carrier film having a first side and a second side, its first adhesive coating being disposed on the first side of the carrier film and comprising at least one heat-activable adhesive, and its second adhesive coating being disposed on the second side of the carrier film and comprising at least one heat-activable adhesive. The carrier film here has, over its two-dimensional extent, a multiplicity of openings which extend continuously through the carrier film from the first side of the carrier film through to the second side of the carrier film.

The invention relates to a heat-activatedly bondable, substantially two-dimensional (“2D”) diecutting element having a carrier, a first adhesive coating and a second adhesive coating, the carrier taking the form of a carrier film having a first side and a second side, the first adhesive coating being disposed on the first side of the carrier film and comprising at least one heat-activable adhesive, and the second adhesive coating being disposed on the second side of the carrier film and comprising at least one heat-activable adhesive.

The significance of adhesive tapes as processing auxiliaries in current industrial applications is continually increasing. Thus even today, in products of the entertainment industry and in other electronic devices, a multiplicity of different components are joined to one another using double-sided adhesive tapes: for example in mobile phones, digital cameras, hand held computers and flat-screen displays. Since devices of this kind are to take increasingly lightweight and compact forms, without resulting in a reduction in their functionality and performance, the electronics industry in particular imposes exacting requirements on the quality of adhesive bonds.

Two components are joined using, in particular, adhesive tapes coated on both sides with pressure-sensitive adhesives. These double-sided adhesive tapes serve as bondable 2D diecutting elements, from which adhesive diecuts are punched, as diecut products, whose form is adapted exactly to the form of the mating surfaces of the components to be joined. Accordingly, in the case of adhesive 2D diecutting elements of this kind, the requirements in terms of dimensional stability and bonding strength are particularly high.

These bondable 2D diecutting elements can in principle be formed without a stabilizing carrier—in the form, for instance, of adhesive transfer tapes. The preparation and processing of such carrier-free bondable 2D diecutting elements, however, are made very much more difficult as a result of the fact that they are difficult to diecut with precision, owing to the flow characteristics of the pressure-sensitive adhesives used. Thus, in particular, diecuts with fine structures, such as thin bridges, for instance, cannot be diecut in carrier-free form from an adhesive transfer tape.

Consequently it is usual for such applications to use bondable 2D diecutting elements which include carriers. The stabilizing carriers used here are typically films or textile nonwovens. When nonwoven carriers are used, the diecut manufactured from them indeed has sufficient dimensional stability, but with the nonwoven carriers there is fibre shedding, so that the fibres of the nonwoven project in the diecutting area and may adversely affect the adhesive bond. For applications of this kind, therefore, carriers made from film materials are preferred. Hence double-sidedly bondable 2D diecutting elements with film carriers offer the advantage of particularly good dimensional stability in conjunction with a high degree of mechanical robustness.

In order to improve the bond strength of the double-sidedly bondable 2D diecutting elements, pressure-sensitive adhesives are replaced by heat-activable adhesives. Given that, in an adhesive bond, the robustness is determined fundamentally by the robustness of the weakest component, improving the bond strength of double-sidedly bondable 2D diecutting elements also requires a stable adhesion of the adhesives to the carrier itself. Thus, using carriers made from nonwovens, it is possible to produce heat-activatedly bondable 2D diecutting elements with high bond strength, but these elements have the disadvantages described above.

In order to improve the diecutting characteristics of the bondable 2D diecutting elements it is desirable, when using heat-activable adhesives as well, to use carriers for these elements that are composed of a film. The bond strength with systems of this kind, however, is much lower than in the case of nonwoven-based 2D diecutting elements, since the anchoring that can be achieved of the heat-activable adhesives on the film materials is usually deficient.

The object of the invention was therefore to provide a heat-activatedly bondable 2D diecutting element with which the adhesives adhere outstandingly to the carrier and which at the same time exhibits very good diecutting characteristics.

It has been possible, surprisingly, to achieve this object by means of a heat-activatedly bondable 2D diecutting element wherein the carrier takes the form of a carrier film having a first side and a second side; wherein the first adhesive coating is disposed on the first side of the carrier film and comprises at least one heat-activable adhesive; and wherein the second adhesive coating is disposed on the second side of the carrier film and comprises at least one heat-activable adhesive, the carrier film having over its two-dimensional extent a multiplicity of openings which extend continuously through the carrier film, from the first side of the carrier film through to the second side of the carrier film. Via these openings the adhesive of the first adhesive coating is in direct contact with the adhesive of the second adhesive coating. As a result, as well as the adhesion of the adhesives on the carrier film local bonding of both adhesives to one another is obtained, and hence an additional anchorage of the adhesives to the carrier film they enclose.

It is advantageous here for the openings in the carrier film to have internal diameters from a range from 5 μm to 1 mm. Selecting such an internal diameter ensures efficient bonding of the adhesives with one another and hence particularly good anchorage on the carrier film, while at the same time also ensuring the mechanical robustness of the 2D diecutting element. This effect can be achieved in particular with an average internal diameter from a range from 50 μm to 500 μm.

Furthermore, the openings in the carrier film may advantageously have a density per unit area of more than 1 mm⁻². For the above-described internal diameters of the openings, from a range from 50 μm to 500 μm, there are even more favourable densities per unit area: namely, of more than 200 mm⁻², more particularly of more than 5000 mm⁻². This produces particularly uniform robustness of the subsequent bond, as a result of the uniform anchorage of the adhesives on the carrier film, owing to the resulting homogeneous two-dimensional distribution of the openings over the entire two-dimensional extent of the 2D diecutting element.

The openings may further take the form of circular holes. As compared with any other opening geometry, this produces particular stability of the carrier film with respect to external loads, resulting, for instance, in a high tensile strength for the 2D diecutting element.

It is further of advantage if the carrier film has a thickness from a range from 5 μm to 100 μm. This produces particularly good dimensional stability and diecutting characteristics on the part of the 2D diecutting element.

It is further advantageous for the carrier film to be a polyester film, preferably a polyethylene terephthalate film or a polyethylene naphthalate film. Polyester films, firstly, are mechanically stable and hence readily diecuttable. Furthermore, they also have outstanding thermal stability. The latter quality is particularly important when heat-activable adhesives with particularly high activation temperatures are to be bonded to the carrier. In contrast to other conventional carrier systems, such as polyvinyl chloride films or polyethylene films, for instance, polyesters such as polyethylene terephthalates and polyethylene naphthalates withstand the elevated temperatures intact.

It is advantageous if one of the two heat-activable adhesives, the heat-activable adhesive of the first adhesive coating or the heat-activable adhesive of the second adhesive coating, or even both of these adhesives, comprises or comprise a thermoplastic base polymer. Even under a low applied pressure, this base polymer has good flow characteristics, so that the ultimate bond strength, relevant to the durability of a permanent adhesive bond, is set very rapidly, and hence rapid bonding is possible even on a rough or critical substrate.

It is likewise advantageous if one of the two heat-activable adhesives, the heat-activable adhesive of the first adhesive coating or the heat-activable adhesive of the second adhesive coating, or even both adhesives, comprise or comprises an elastomeric base polymer and a modifier resin, the modifier resin comprising a tackifier resin and/or a reactive resin. Through the use of an elastomeric base polymer it is possible to obtain adhesive coatings having outstanding dimensional stability.

Instead of an adhesive of this kind it is possible alternatively, for the heat-activable adhesive of the first adhesive coating and/or the heat-activable adhesive of the second adhesive coating, to use adhesives of a kind comprising 50% to 95% by weight of a bondable polymer and 5% to 50% by weight of an epoxy resin or mixture of two or more epoxy resins. In this case the bondable polymer advantageously comprises 40% to 94% by weight of acrylic acid compounds and/or methacrylic acid compounds of the formula CH₂═CH(R¹)(COOR²) (R¹ here represents a radical selected from the group consisting of H and CH₃, and R² represents a radical selected from the group consisting of H and alkyl chains having 1 to 30 carbon atoms) and 5% to 30% by weight of a first copolymerizable vinyl monomer which has at least one carboxylic acid group and/or sulphonic acid group and/or phosphonic acid group, 1% to 10% by weight of a second copolymerizable vinyl monomer which has at least one epoxide group or one acid anhydride function and 0% to 20% by weight of a third copolymerizable vinyl monomer which has at least one functional group which differs from the functional group of the first copolymerizable vinyl monomer and from the functional group of the second copolymerizable vinyl monomer. An adhesive of this kind allows rapidly activable bonding with a rapidly attained ultimate bond strength, and ensures a firmly adhering join to apolar substrates.

Finally it is advantageous for at least one of the two heat-activable adhesives, the heat-activable adhesive of the first adhesive coating and the heat-activable adhesive of the second adhesive coating, to comprise 40% to 98% by weight of acrylate-containing block copolymer, 2% to 50% by weight of one or more tackifying epoxy resins and/or novolak resins and/or phenolic resins and 0% to 10% by weight of curing agents for crosslinking the epoxy resins and/or novolak resins and/or phenolic resins. As a result of physical crosslinking within the polymer, a formulation of this kind offers the advantage that adhesive coatings with a large overall thickness can be obtained without adverse effects on the load-bearing capacity of the adhesive bond. As a result of this, these adhesive coatings are suitable for compensating unevennesses in the substrate. Moreover, an adhesive of this kind exhibits good ageing stability and only minor outgassing, which is particularly desirable in the case of numerous adhesive bonds in the electronics sector.

A further object of the present invention was to provide a dimensionally stable diecut for high-strength adhesive bonding of components in the consumer electronics sector. Accordingly the invention embraces a heat-activatedly bondable diecut cut from the heat-activatedly bondable 2D diecutting element described above. Through the use of the heat-activatedly bondable 2D diecutting element as the raw diecutting body, the dimensional stability and, at the same time, the mechanical stability of the diecut are ensured and in addition it is made certain that the bond obtainable using this diecut has good load-bearing capacity.

A further object of the invention was to permit processes for producing such heat-activatedly bondable 2D diecutting elements, and correspondingly dimensionally stable diecuts.

The invention accordingly also provides a process for producing the heat-activatedly bondable 2D diecutting element described above, which comprises coating the first side of the carrier film provided two-dimensionally with a multiplicity of continuous openings with the first adhesive coating of at least one heat-activable adhesive and coating the second side of the carrier film provided two-dimensionally with a multiplicity of continuous openings with a second adhesive coating of at least one heat-activable adhesive.

Finally, the invention provides a process for producing the diecut described above, comprising coating at least one side of the heat-activatedly bondable 2D diecutting element above with a two-dimensional release agent, diecutting the 2D diecutting element coated at least on one side with the two-dimensional release agent into a desired shape.

As carrier film it is possible to use carrier films made from any suitable materials and in any typical designs. Preference is given to using carrier films made from polyesters such as, for example, polyethylene terephthalate and the like, with particular preference from polyethylene naphthalate.

The film preferably has a thickness from a range from 5 μm to 100 μm. As the thickness of the film goes up its rigidity increases, as does, consequently, that of the bondable 2D diecutting element, thereby producing, overall, an improvement in its diecuttability.

In accordance with the invention the carrier film has a multiplicity of openings. This perforation extends over at least a major portion of the two-dimensional extent of the carrier film, and results in particularly strong anchorage of the two adhesive coatings on the film. These openings reach through the carrier film, i.e., from the first side of the carrier film through to its second side, and overall, therefore, are continuous. The perforation may have been made in the carrier film using all conventional methods, such as by means of hot needling or laser perforation of the carrier film.

The openings produced in this perforation procedure have internal diameters from a range from 5 μm to 1 mm. The internal diameter or clear width of the openings is preferably situated in a range from 50 μm to 500 μm. The dimensions given as internal diameters relate in this case to the width of the hole in the form of a smallest respective dimension for the hole opening, in other words the diameter of a circular hole, the edge length of a square hole or the width of an elongated hole. In the case of an elongated hole, the length of the hole may also be situated within this range, i.e. the length of the elongated hole as the greater clearance, but it may also be much larger than the width of the hole. The hole division, in other words the distance from centre to centre of two adjacent holes, which affects the bridge width of the carrier films, the smallest unperforated space between two adjacent holes, is selected in accordance with the particular properties desired for the 2D diecutting element, and can be situated within the same order of magnitude as the internal diameter of the perforation or else may also be much larger or even smaller.

The openings of this microperforation may have any desired forms, both regular and irregular. Thus they may have fairly angular forms, fairly rectangular cross sections such as squares or slots, or else round forms, such as circular or elliptical cross sections, for example. The openings preferably take the form of round holes, so as to maintain the tensile strength of the carrier film. These openings may also possess different depth profiles—for instance, with a cross section which is the same over the entire depth of the opening, or else with a cross section which widens or tapers to the inside of the film. In a 2D diecutting element it is of course also possible to use different forms of hole: for example, openings with a square cross section and openings with a circular cross section alongside one another, or else—separated in different areas of the carrier film—circular openings at the edge of the carrier film and elongated elliptical openings in its central area.

The arrangement of the openings on the surface of the carrier film can in principle be arbitrary. Depending on the specific field of use of the 2D diecutting element, the openings on the carrier film may, for example, be arranged in patterns or irregularly distributed, or else arranged with different densities per unit area, such as, for instance, with a density per unit area that increases or decreases towards the edge. Preference is given here to an (average) density per unit area of more than 1 mm⁻². Depending on the size of the openings, the (average) density per unit area for relatively small internal diameters may also be more than 200 mm⁻², and for internal diameters in the micrometer range it may even be more than 5000 mm⁻². For speciality applications it is of course also possible to design different forms of the openings in different regions of the carrier film, each with different areal densities.

For the further improvement of its adhesion, moreover, the carrier film may have been provided on one or both sides with an adhesion promoter, referred to as a primer. As primers of this kind it is possible to use conventional primer systems, such as heat-sealing adhesives based on polymers such as ethyl vinyl acetate or functionalized ethyl vinyl acetates or else reactive polymers. Functional groups which can be used include all typical adhesion-promoting groups, such as epoxide, aziridine, isocyanate or maleic anhydride groups. Furthermore, the primers may also have had additional crosslinking components added to them, examples being melamine resins or melamine-formaldehyde resins. For polyethylene naphthalate carrier films, highly suitable primers include those based on polyvinylidene chloride and copolymers of vinylidene dichloride, in particular with vinyl chloride (such as Saran from the Dow Chemical Company).

As adhesives it is possible in principle to use all typical heat-activable adhesive systems. In this context, depending on the field of use, the adhesive of the first adhesive coating may be different from that of the second adhesive coating (in the case, for instance, of different substrate materials to be joined to one another), or the two adhesives may be identical.

Described in the text below, purely by way of example, are some typical systems of heat-activable adhesives which have been found to be particularly advantageous in the context of the present invention; specifically, adhesives based on synthetic rubbers, on thermoplastic materials, on elastomers with modifier resins, on acrylic acid derivative-vinyl copolymers and on acrylate-containing block copolymers.

Thus the heat-activable adhesive may have been formed on the basis of thermoplastic materials or thermoplastics. Such thermoplastic materials encompass all suitable thermoplastics, examples being polyurethanes, polyesters, polyamides, ethylene-vinyl acetates, synthetic rubbers such as, for example, styrene-isoprene-styrene (SIS) block copolymers, styrene-butadiene-styrene (SBS) block copolymers, styrene-ethylene-butadiene-styrene (SEBS) block copolymers, polyvinyl acetate, polyimides, polyethers, copolyamides, copolyesters, polyolefins such as polyethylene, polypropylene, polyacrylates or polymethacrylates. Polymers of this kind typically possess softening ranges situated within a temperature range between 45° C. and 205° C. It is of course sensible here to adapt the polymer to the carrier film: in such a way, for instance, that the softening range of the material of the carrier film is situated at higher temperatures than the softening range of the adhesive.

As thermoplastic materials it is likewise possible to use polyolefins, more particularly poly-α-olefins. The adhesives based on such poly-α-olefins frequently have static softening temperatures T_{E,A} or melting points T_{M,A} in a range from 45° C. to 205° C. For this purpose it is possible for example to use the poly-α-olefins sold by Degussa under the name Vestoplast™.

Below, softening temperatures should be understood as being a glass transition temperature for amorphous systems and a melting temperature in the case of semi-crystalline polymers. The temperatures reported here correspond to those obtained from quasi-steady-state experiments such as by means, for example, of DSC.

It is of course also possible for a heat-activable adhesive of this kind based on thermoplastic materials to further comprise additional formulating ingredients and/or auxiliaries, in so far as this is necessary or desired for targeted control over certain properties of the adhesive or of the bond in accordance with the particular end use. Thus, for example, in order to improve the adhesive properties and the activation range of the adhesive, it is possible to add modifier resins such as bond strength enhancer resins and/or reactive resins. The fraction of the resins is typically between 2% and 50% by weight, based in each case on the mass of the thermoplastic material. The bond strength of poly-α-olefins can also be raised, however, by means of controlled additizing. For instance, it is possible in this case to use polyimine copolymers or polyvinyl acetate copolymers as bond strength promoters.

As bond strength enhancer resins or tackifying resins—known as tackifier resins—it is possible without exception to use all known tackifier resins described in the literature, examples being pinene resins, indene resins and rosins, their disproportionated, hydrogenated, polymerized and esterified derivatives and salts, the aliphatic and aromatic hydrocarbon resins, terpene resins and terpene-phenolic resins, and also C5, C9 and other hydrocarbon resins. These and further resins can be used individually or in any combinations in order to set the properties of the resultant adhesive in accordance with requirements. Generally speaking it is possible to use any resins that are compatible with (soluble) the thermoplastic material in question, more particularly aliphatic, aromatic or alkylaromatic hydrocarbon resins, hydrocarbon resins based on pure monomers, hydrogenated hydrocarbon resins, functional hydrocarbon resins and natural resins. Express reference is made to the depiction of the state of the art in the “Handbook of Pressure Sensitive Adhesive Technology” by Donatas Satas (van Nostrand, 1989).

Reactive resins which can be used are all typical reactive resins, examples being those based on epoxy resin with molecular weights varying approximately in the range from 100 g/mol up to a maximum of 1000 g/mol. Epoxy resins which can be used include all suitable epoxy resins, particularly the different kinds listed below.

A heat-activable adhesive may alternatively be formed on the basis of elastomeric base polymers and at least one modifier resin. As the elastomeric base polymer it is possible to employ any suitable elastomeric polymers, examples being rubbers, nitrile rubbers, epoxidized nitrile rubbers, polychloroisoprenes and polyacrylates. The rubbers may be natural rubbers or synthetic rubbers. Suitable synthetic rubber includes all typical synthetic rubber systems, such as those based on polyvinylbutyral, polyvinylformal, nitrile rubbers, nitrile-butadiene rubbers, hydrogenated nitrile-butadiene rubbers, polyacrylate rubbers, chloroprene rubbers, ethylene-propylene-diene rubbers, methyl-vinyl-silicone rubbers, fluorosilicone rubbers, tetrafluoroethylene-propylene copolymer rubbers, butyl rubbers or styrene-butadiene rubbers. The synthetic rubbers are advantageously selected so as to have a softening temperature or glass transition temperature from a temperature range from −80° C. to 0° C.

Commercial examples of nitrile-butadiene rubbers are for instance Europrene™ from Eni Chem, or Krynac™ from Bayer, or Breon™ and Nipol N™ from Zeon. Polyvinylformals can be purchased, for instance, as Formvar™ from Ladd Research. Polyvinylbutyrals are available as Butvar™ from Solucia, as Pioloform™ from Wacker and as Mowital™ from Kuraray. Hydrogenated nitrile-butadiene rubbers available include, for example, the products Therban™ from Bayer and Zetpol™ from Zeon. Polyacrylate rubbers are in commerce, for example, as Nipol AR™ from Zeon. An instance of an available chloroprene rubber is Baypren™ from Bayer. Ethylene-propylene-diene rubbers can be acquired, for example, as Keltan™ from DSM, as Vistalon™ from Exxon Mobile and as Buna EP™ from Bayer. Methyl-vinyl-silicone rubbers are available, for instance, as Silastic™ from Dow Corning and as Silopren™ from GE Silicones. An example of a suitable fluorosilicone rubber is Silastic™ from GE Silicones. Butyl rubbers are obtainable for instance as Esso Butyl™ from Exxon Mobile. Useful styrene-butadiene rubbers include Buna S™ from Bayer, Europrene™ from Eni Chem and Polysar S™ from Bayer.

Capable of serving as modifier resins are all resins which influence the adhesive properties of the adhesive, more particularly bond strength enhancer resins and reactive resins. As a bond strength enhancer resin it is possible to use all of the known tackifier resins, more particularly those listed above. Reactive resins which can be used are all typical reactive resins, examples being epoxy resins, phenolic resins, terpene-phenolic resins, melamine resins, resins of isocyanate groups, or mixtures of these resins. As epoxy resins it is possible to use all suitable epoxy resins, more particularly the different kinds listed below. Phenolic resins which can be used are conventional phenolic resins, such as YP 50 from Toto Kasei, PKHC from Union Carbide Corp. or BKR 2620 from Showa Union Gosei Corp. Terpene-phenolic resins which can be used are all typical terpene-phenolic resins, an example being NIREZ™ 2019 from Arizona Chemical. Melamine resins which can be used are all typical melamine resins, examples being Cymel™ 327 and 323 from Cytec. Serving as resins with isocyanate groups may be typical resins functionalized with isocyanate groups, examples being Coronate™ L from Nippon Polyurethan Ind., Desmodur™ N3300 or Mondur™ 489 from Bayer.

A heat-activable adhesive of this kind, based on elastomeric base polymers with modifier resins, may of course further comprise additional formulating ingredients and/or auxiliaries, provided this is necessary or desired for the targeted control of certain properties of the adhesive or of the bond, in accordance with the particular end use. Particularly in combination with the reactive systems, a multiplicity of other additives are frequently used, such as resins, filling materials, catalysts, ageing inhibitors and the like.

Alternatively the heat-activable adhesive may be formed on the basis of acrylic acid derivative-vinyl copolymers. As elastomeric acrylic acid derivative-vinyl copolymers it is possible to use all suitable copolymers which include units of acrylic acid derivatives, more particularly acrylic esters, and vinyl units, preferably copolymers based on a bondable polymer and one or more epoxy resins.

Compositions which have emerged as being particularly advantageous are those of the following kind:
a) 50%-95% by weight of a bondable polymer and
b) 5%-50% by weight of an epoxy resin or mixture of two or more epoxy resins.

The composition of the bondable polymer is preferably as follows:
a1) 40% to 94% by weight of acrylic acid compounds and/or methacrylic acid compounds of the formula CH₂═CH(R¹)(COOR²), R¹ representing a radical selected from the group consisting of H and CH₃, and R² representing a radical selected from the group consisting of H and alkyl chains having 1 to 30 carbon atoms,
a2) 5% to 30% by weight of a first copolymerizable vinyl monomer which has at least one carboxylic acid group and/or sulphonic acid group and/or phosphonic acid group,
a3) 1% to 10% by weight of a second copolymerizable vinyl monomer which has at least one epoxide group or one acid anhydride function and
a4) 0% to 20% by weight of a third copolymerizable vinyl monomer which has at least one functional group which differs from the functional group of the first copolymerizable vinyl monomer and from the functional group of the second copolymerizable vinyl monomer and which is suitable for increasing the cohesion of the bondable polymer, for increasing the reactivity of crosslinking or for contributing to direct crosslinking.

The polymer a) may itself be of a heat-activably bonding nature. Alternatively, as a pure base polymer, it may initially be adhesive, the adhesive then itself no longer being adhesive in the blend with the epoxy resins, as a result of the raising of the temperature range of a glass transition (T_{g}) as a result of the epoxy resins.

The bondable polymer a) may therefore comprise a heat-activable pressure-sensitive adhesive which becomes adhesive on temperature exposure and optional pressure and which develops a high bond strength after bonding and cooling, as a result of the solidification. Depending on the application temperature, these heat-activable pressure-sensitive adhesives have different static glass transition temperatures T_{g,A} or melting points T_{m,A}.

As monomers a1) it is possible for instance to use acrylic monomers which comprise acrylic and methacrylic esters with alkyl groups of 4 to 14 C atoms, typically of 4 to 9 C atoms. Specific examples, without wishing to be restricted by this enumeration, are n-butyl acrylate, n-pentyl acrylate, n-hexyl acrylate, n-heptyl acrylate, n-octyl acrylate, n-nonyl acrylate, lauryl acrylate, stearyl acrylate, behenyl acrylate or their branched isomers such as 2-ethylhexyl acrylate. Further substances which may likewise be added to the monomers a1), in small amounts, are methyl methacrylates, cyclohexyl methacrylates, isobornyl acrylates or isobornyl methacrylates.

As monomers a2) it is possible for example to use itaconic acid, acrylic acid, methacrylic acid, vinylacetic acid, fumaric acid, crotonic acid, aconitic acid, dimethylacrylic acid, β-acryloyloxypropionic acid, trichloroacrylic acid, vinylphosphonic acid or vinylsulphonic acid.

As monomers a3) it is possible for instance to use glycidyl methacrylate, maleic anhydride or itaconic anhydride.

For the monomers a4) different classes of compound can be used. Thus as monomers a4) it is possible, for example, to employ vinyl esters, vinyl ethers, vinyl halides, vinylidene halides, vinyl compounds with aromatic rings and heterocycles in α position, such as vinyl acetate, vinylformamide, vinylpyridine, ethyl vinyl ether, vinyl chloride, vinylidene chloride or acrylonitrile.

As monomers a4) it is likewise possible to use monomers containing hydroxyl groups, acid amide groups, isocyanate groups or amino groups.

Other examples of component a4) are hydroxyethyl acrylate, hydroxypropyl acrylate, hydroxyethyl methacrylate, hydroxypropyl methacrylate, allyl alcohol, acrylamide, benzyl acrylate, benzyl methacrylate, phenyl acrylate, phenyl methacrylate, tert-butylphenyl acrylate, tert-butylphenyl methacrylate, phenoxyethyl acrylate, phenoxyethyl methacrylate, 2-butoxyethyl methacrylate, 2-butoxyethyl acrylate, dimethylaminoethyl methacrylate, dimethylaminoethyl acrylate, diethylaminoethyl methacrylate, diethylaminoethyl acrylate, cyanoethyl methacrylate, cyanoethyl acrylate, 6-hydroxyhexyl methacrylate, N-tert-butylacrylamide, N-methylolmethacrylamide, N-(butoxymethyl)methacrylamide, N-methylolacrylamide, N-(ethoxymethyl)acrylamide, N-isopropylacrylamide and tetrahydrofurfuryl acrylate, this enumeration not being conclusive.

Furthermore, it is also possible as component a4) to use aromatic vinyl compounds, the aromatic nuclei typically being composed of C₄ to C₁₈ and possibly also containing heteroatoms. Examples of such are styrene, 4-vinylpyridine, N-vinylphthalimide, methylstyrene, 3,4-dimethoxystyrene and 4-vinylbenzoic acid, this enumeration not being conclusive.

The exemplarily and in no way restrictingly enumerated monomers of monomer groups a1) to a4) may within these groups be used individually or else as mixtures of different monomers.

For the polymerization the monomers are selected such that the resulting bondable polymers can be used as heat-activable adhesives or as pressure-sensitive adhesives, more particularly such that the resulting base polymers have adhesive or pressure-sensitive adhesive properties in the sense of the “Handbook of Pressure Sensitive Adhesive Technology” by Donatas Satas (van Nostrand, N.Y. 1989). Targeted control over the glass transition temperature can be directed for this purpose via the make-up of the monomer mixture on which the polymerization is based.

In order to obtain a polymer glass transition temperature T_{g,A} of ≧30° C. for heat-activable adhesives, the monomers are selected, and the quantitative composition of the monomer mixture chosen, in such a way as to give the desired T_{g,A} value for the polymer in accordance with equation (E1), in analogy to the equation presented by Fox (cf. T. G. Fox, Bull. Am. Phys. Soc. 1 (1956) 123) as follows:

$$\frac{1}{{T}_{g}} = {\sum }_{n}^{ } \frac{{w}_{n}}{{T}_{g , n}} . \qquad ( E 1 )$$

In this equation n represents the serial number of the monomers used, wₙ the mass fraction of the respective monomer n (in % by weight) and T_{G,n} the respective glass transition temperature of the homopolymer of the respective monomer n (in K). For pressure-sensitive adhesives a static glass transition temperature lower than 15° C. would advantageously be chosen.

Base polymers of this kind can be prepared in the typical synthesis processes for such polymers, as for example in conventional free-radical polymerizations or in controlled free-radical polymerizations. For the polymerizations which proceed by a free-radical mechanism, initiator systems are used which contain further free-radical initiators for the polymerization, more particularly thermally decomposing free-radical-forming azo or peroxo initiators. Suitable in principle, however, are all of the initiators that are typical for acrylates and familiar to the skilled person. The production of C-centred free radicals is described for instance in Houben-Weyl, Methoden der Organischen Chemie, Vol. E 19a, pp. 60-147. These methods may be employed analogously, inter alia.

Examples of radical sources in suitable free-radical initiators systems are, for example, peroxides, hydroperoxides and azo compounds, such as potassium peroxodisulphate, dibenzoyl peroxide, cumene hydroperoxide, cyclohexanone peroxide, di-tert-butyl peroxide, azodiisobutyronitrile, cyclohexylsulphonyl acetyl peroxide, diisopropyl percarbonate, tert-butyl peroctoate, benzpinacol and the like. Thus, for example, as free-radical initiator it is possible to use 1,1′-azobis(cyclohexanecarbonitrile), which is available commercially under the name Vazo 88™ from the company DuPont.

The number-averaged molecular weights Mₙ of the adhesives formed in the free-radical polymerization are selected, for example, so as to lie within a range from 20 000 to 2 000 000 g/mol; specifically for use as hot-melt pressure-sensitive adhesives, pressure-sensitive adhesives having average molecular weights Mₙ of 100 000 to 500 000 g/mol are prepared. The average molecular weight is determined via size exclusion chromatography (SEC) or matrix-assisted laser desorption/ionization coupled with mass spectrometry (MALDI-MS).

The polymerization can be conducted in bulk (without solvent), in the presence of one or more organic solvents, in the presence of water or in mixtures of organic solvents and water. The aim is typically to minimize the amount of solvent used. Suitable organic solvents include pure alkanes (e.g. hexane, heptane, octane or isooctane), aromatic hydrocarbons (e.g. benzene, toluene or xylene), esters (e.g. ethyl, propyl, butyl or hexyl acetate), halogenated hydrocarbons (e.g. chlorobenzene), alkanols (e.g. methanol, ethanol, ethylene glycol and ethylene glycol monomethyl ether) and ethers (e.g. diethyl ether and dibutyl ether) and mixtures thereof. Aqueous polymerization reactions can be admixed with a water-miscible or hydrophilic cosolvent so as to ensure that the reaction mixture is in the form of a homogeneous phase during monomer conversion. Cosolvents which can be used for example are from the group consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulphides, sulphoxides, sulphones, alcohol derivatives, hydroxyether derivatives, amino alcohols, ketones and the like, and also derivatives and mixtures of these.

Depending on conversion and temperature, the polymerization time can be between 4 and 72 hours. The higher the level at which it is possible to select the reaction temperature, in other words the higher the thermal stability of the reaction mixture, the lower the reaction time can be.

For the thermally decomposing initiators the introduction of heat is essential to initiate the polymerization. For such thermally decomposing initiators the polymerization can be initiated by heating at 50 to 160° C., depending on initiator type.

For radical stabilization typical radical stabilizers can be used, such as nitroxides of type (NIT 1) or (NIT 2):

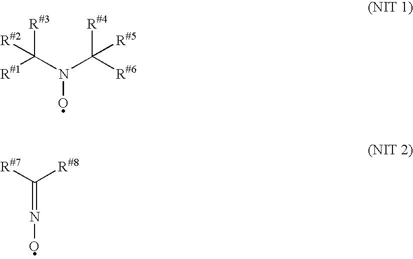

where R^{#1}, R^{#2}, R^{#3}, R^{#4}, R^{#5}, R^{#6}, R^{#7} and R^{#8} independently of one another denote the following atoms or groups:
i) halides, such as chlorine, bromine or iodine, for example;
ii) linear, branched, cyclic and heterocyclic hydrocarbons having 1 to 20 carbon atoms, which may be saturated, unsaturated or aromatic;
iii) esters —COOR^{#9}, alkoxides —OR^{#10} and/or phosphonates —PO(OR^{#11})₂, where R^{#9}, R^{#10} and/or R^{#11} stand for radicals from group ii) above.

Compounds of structure (NIT 1) or (NIT 2) can also be attached to polymer chains of any kind (primarily such that at least one of the abovementioned radicals constitutes such a polymer chain) and can therefore be used in synthesizing block copolymers, as macroradicals or macroregulators.

As controlled regulators for the polymerization it is likewise possible to use compounds of the following types:
2,2,5,5-tetramethyl-1-pyrrolidinyloxyl(PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-1-piperidinyloxyl(TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-tert-butyl nitroxide
diphenyl nitroxide
tert-butyl tert-amyl nitroxide.

A range of further polymerization methods by which adhesives can be prepared in an alternative procedure can be selected from the prior art:

Thus U.S. Pat. No. 4,581,429 A discloses a controlled-growth radical polymerization process initiated using a compound of the formula R′R″N—O—Y in which Y is a free radical species which is able to polymerize unsaturated monomers. The reactions, however, generally have low conversions. A particular problem is the polymerization of acrylates, which proceeds only to very low yields and with low molecular masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process using specific radical compounds such as, for example, phosphorus-containing nitroxides which are based on imidazolidine. WO 98/44008 A1 discloses specific nitroxyls based on morpholines, piperazinones and piperazinediones. DE 199 49 352 A1 describes heterocyclic alkoxyamines as regulators in controlled-growth radical polymerizations. Corresponding further developments of the alkoxyamines and of the corresponding free nitroxides enhance the efficiency for preparing polyacrylates.

As a further controlled polymerization method it is possible to use atom transfer radical polymerization (ATRP) to synthesize copolymers, with typically monofunctional or difunctional secondary or tertiary halides being used as initiators and, to abstract the halide(s), complexes of Cu, Ni, Fe, Pd, Pt, Ru, Os, Rh, Co, Ir, Ag or Au being used (cf. EP 0 824 111 A1; EP 826 698 A1; EP 824 110 A1; EP 841 346 A1; EP 850 957 A1). The different possibilities of ATRP are further described in U.S. Pat. No. 5,945,491 A, U.S. Pat. No. 5,854,364 A and U.S. Pat. No. 5,789,487 A.

It is also possible to prepare the base polymer in a living polymerisation, such as an anionic polymerization. In this case the reaction medium used typically comprises inert solvents, such as aliphatic and cycloaliphatic hydrocarbons or aromatic hydrocarbons.

The living polymer is generally represented as P_{L}(A)-Me, where Me is a metal from group I of the Periodic Table (such as lithium, sodium or potassium) and P_{L}(A) is a growing polymer block of the monomers [a1)-a4)]. The molar mass of the polymer is predetermined by the ratio of initiator concentration to monomer concentration.

Suitable polymerization initiators include n-propyllithium, n-butyllithium, sec-butyllithium, 2-naphthyllithium, cyclohexyllithium and octyllithium, though this enumeration makes no claim to completeness. Initiators based on samarium complexes are also known for the polymerization of acrylates (Macromolecules, 1995, 28, 7886) and can be used as well.

It is also possible, moreover, to use difunctional initiators, such as 1,1,4,4-tetraphenyl-1,4-dilithiobutane or 1,1,4,4-tetraphenyl-1,4-dilithioisobutane, for example. Coinitiators may likewise be employed, such as lithium halides, alkali metal alkoxides and alkylaluminium compounds, for example. Thus the ligands and coinitiators may be chosen so that acrylate monomers, such as n-butyl acrylate and 2-ethylhexyl acrylate, for example, can be polymerized directly and do not have to be generated in the polymer by transesterification with the corresponding alcohol.

Another suitable preparation process is a version of RAFT polymerization (reversible addition-fragmentation chain transfer polymerization). This kind of polymerization process is described in detail in, for example, WO 98/01478 A1 and WO 99/31144 A1. Suitable for the preparation are trithiocarbonates of the general structure R′″—S—C(S)—S—R′″ (Macromolecules 2000, 33, 243-245).

In another version, for example, thio compounds such as the trithiocarbonates (TTC1) and (TTC2) or the thio compounds (THI1) and (THI2) are used for the polymerization, in which Φ can be a phenyl ring, which can be unfunctionalized or functionalized by alkyl or aryl substituents attached directly or via ester or ether bridges, or can be a cyano group, or can be a saturated or unsaturated aliphatic radical. The phenyl ring Φ may optionally bear one or more long-chain polymer substrates, examples being polybutadiene, polyisoprene, polychloroprene, polystyrene or poly(meth)acrylate. Examples of possible functionalizations include halogens, hydroxyl groups, epoxide groups or groups containing nitrogen atoms or sulphur atoms.

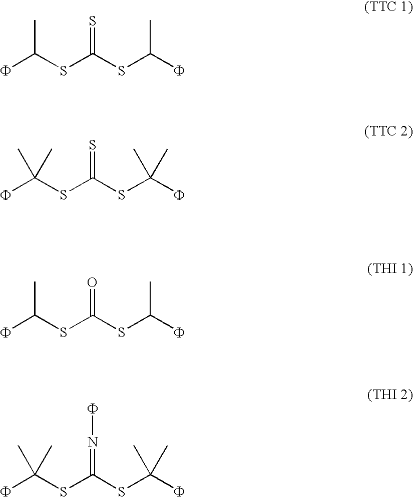

It is additionally possible to employ thioesters of the general structure

R^{$1}—C(S)—S—R^{$2} (THE),

particularly in order to prepare asymmetric systems. R^{$1} and R$² may be selected independently of one another and R^{$1} can be a radical from one of groups i) to iv) below, and R^{$2} a radical from one of groups i) to iii) below:
i) C₁ to C₁₈ alkyl, C₂ to C₁₈ alkenyl, C₂ to C₁₈ alkynyl, each linear or branched; aryl, phenyl, benzyl, aliphatic and aromatic heterocycles;
ii)

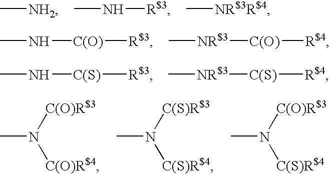

(where R^{$3} and R^{$4} are radicals selected independently of one another from group i);
iii) —S—R^{$5} or —S—C(S)—R^{$5}, where R^{$5} can be a radical from one of groups i) and ii);
iv) —O—R^{$6} or —O—C(O)—R^{$6}, where R^{$5} can be a radical from one of groups i) and ii).

In connection with the abovementioned controlled-growth free-radical polymerizations, preferred initiator systems are those additionally comprising further free-radical initiators for the polymerization, especially thermally decomposing radical-forming azo or peroxo initiators. In principle, however, all initiators known for acrylates are suitable for this purpose. The production of C-centred radicals is described in Houben-Weyl, Methoden der Organischen Chemie, Vol. E19a, p. 60ff. These methods are employed preferentially.

Examples of radical sources are peroxides, hydroperoxides and azo compounds. As a number of nonexclusive examples of typical radical initiators mention may be made here of the following: potassium peroxodisulphate, dibenzoyl peroxide, cumene hydroperoxide, cyclohexanone peroxide, cyclohexylsulphonyl acetyl peroxide, di-tert-butyl peroxide, azodiisobutyronitrile, diisopropyl percarbonate, tert-butyl peroctoate and benzpinacol. Likewise useful as free-radical initiators are 1,1′-azobis(cyclohexylnitrile) (Vazo 88®, DuPont®) or 2,2-azobis(2-methylbutanenitrile) (Vazo 67®, DuPont®). It is also possible, furthermore, to use radical sources which release radicals only when stimulated by light from the UV region of the spectrum.

In the conventional RAFT process polymerization is conducted usually only to low conversions (WO 98/01478 A1) in order to realize molecular weight distributions which are as narrow as possible. As a result of the low conversions, however, these polymers cannot be used as pressure-sensitive adhesives (PSAs) and in particular not as hotmelt PSAs, since the high residual monomer content impacts negatively on the technical adhesive properties, the residual monomers contaminate the solvent recyclate in the concentration process, and the self-adhesive tapes produced with them would exhibit severe outgassing.

The epoxy resins encompass the entire group of epoxide compounds. Thus the epoxy resins may be monomers, oligomers or polymers. Polymeric epoxy resins may be aliphatic, cycloaliphatic, aromatic or heterocyclic in nature. The epoxy resins typically have at least two epoxide groups which can be utilized for crosslinking.

The molecular weight of the epoxy resins varies from 100 g/mol up to a maximum of 25 000 g/mol for polymeric epoxy resins.

The epoxy resins encompass all typical epoxides, such as the reaction product of bisphenol A and epichlorohydrin, the reaction product of phenol and formaldehyde (known as novolak resins) and epichlorohydrin, glycidyl esters or the reaction product of epichlorohydrin and p-aminophenol.

Epoxy resins of this kind are available commercially, for example as Araldite™ 6010, CY-281™, ECN™ 1273, ECN™ 1280, MY 720, RD-2 from Ciba Geigy, as DER™ 331, DER™ 732, DER™ 736, DEN™ 432, DEN™ 438, DEN™ 485 from Dow Chemical, as Epon™ 812, 825, 826, 828, 830, 834, 836, 871, 872,1001, 1004, 1031 etc. and as HPT™ 1071, HPT™ 1079, the latter from Shell Chemical.

Examples of commercial aliphatic epoxy resins are for example vinylcyclohexane dioxides such as ERL-4206, ERL-4221, ERL 4201, ERL-4289 or ERL-0400 from Union Carbide Corp.

An adhesive may of course comprise further formulating ingredients and/or auxiliaries, such as, for example, fillers, pigments, rheological additives, additives for promoting the adhesion, plasticizers, resins, elastomers, ageing inhibitors (antioxidants), light stabilizers, UV absorbers, and other auxiliaries and additives, examples being dryers (such as molecular sieve zeolites, calcium oxide), flow control and levelling agents and/or wetting agents such as surfactants, or catalysts.

Fillers which can be used are all finely ground solid additives such as, for example, chalk, magnesium carbonate, zinc carbonate, kaolin, barium sulphate, titanium dioxide or calcium oxide. Further examples are talc, mica, silica, silicates or zinc oxide. Mixtures of the substances stated may of course also be used.

The pigments used may be organic or inorganic in nature. All kinds of organic or inorganic colour pigments are suitable, examples being white pigments such as titanium dioxide for improving the light stability and UV stability, or metal pigments.

Examples of rheological additives are pyrogenic (or fumed) silicas, phyllosilicates (for example bentonites), high molecular mass polyamide powders or powders based on castor oil derivatives.

Additives for promoting the adhesion may, for example, be substances from the groups of the polyamides, epoxides or silanes.

Examples of plasticizers are phthalic esters, trimellitic esters, phosphoric esters, adipic esters and esters of other acyclic dicarboxylic acids, fatty acid esters, hydroxycarboxylic esters, alkylsulphonic esters of phenol, aliphatic, cycloaliphatic and aromatic mineral oils, hydrocarbons, liquid or semi-solid rubbers (for example nitrile rubbers or polyisoprene rubbers), liquid or semi-solid polymers of butene and/or isobutene, acrylic esters, polyvinyl ethers, liquid resins and plasticizer resins based on the raw materials which also represent the basis of tackifier resins, woolwax and other waxes, silicones, and polymer plasticizers such as polyesters or polyurethanes, for instance.

Suitable resins are all natural and synthetic resins such as, for instance, rosin derivatives (for example, derivatives formed by disproportionation, hydrogenation or esterification), coumarone-indene resins and polyterpene resins, aliphatic or aromatic hydrocarbon resins (C-5, C-9, (C-5)₂ resins), mixed C-5/C-9 resins, hydrogenated and part-hydrogenated derivatives of the stated types, resins formed from styrene or α-methylstyrene, and also terpene-phenolic resins and the like, as set out for instance in Ullmann's Enzyklopadie der technischen Chemie, volume 12, pp. 525-555 (4th ed.), Weinheim.

Suitable elastomers are, for example, copolymers of ethylene-propylene rubbers (in terpolymer form known as EPDM rubber, in copolymer form known as EPM rubber), polyisobutylene, butyl rubber, ethylene-vinyl acetate, hydrogenated block copolymers of dienes (for example by hydrogenation of styrene-butadiene rubber (known as SBR), carboxylated styrene-butadiene rubber (known as cSBR), acrylonitrile-butadiene rubber (known as NBR), styrene/butadiene/styrene triblock copolymers (known as SBS), elastomeric copolymers of styrene and isoprene (known as SIS) or isoprene rubber (known as IR); polymers of this kind are, for example, styrene/ethylene/propylene/styrene copolymers (known as SEPS) and styrene/ethylene/butadiene/styrene copolymers (known as SEBS)) or acrylate copolymers such as acrylate rubber (known as ACM).

The formulating of the adhesive with further ingredients such as fillers and plasticizers, for example, is likewise state of the art.

Finally, the heat-activable adhesive may also take the form of an adhesive based on acrylate-containing block copolymers. Suitable such heat-activable adhesives based on acrylate-containing block copolymers include, in particular, all of the adhesives having the following composition:
a) 40% to 98% by weight of acrylate-containing block copolymers,
b) 2% to 50% by weight of one or more tackifying epoxy resins and/or novolac resins and/or phenolic resins and
c) 0% to 10% by weight of curing agents for crosslinking the epoxy resins and/or novolac resins and/or phenolic resins.

In general the acrylate block copolymers can be described by the stoichiometric formula [P(A)ᵢP(B)ⱼ]ₖ (I). A and B here stand for one or else two or more monomers of type A and, respectively, for one or more monomers of type B, which can be used to prepared the respective polymer block. P(A) stands for a polymer block obtained by polymerizing at least one monomer of type A. P(B) stands for a polymer block obtained by polymerizing at least one monomer of type B.

Thus it is possible, as heat-activable adhesives based on acrylate block copolymers, to use those block copolymers which comprise a combination of polymer blocks P(A) and P(B) which are linked chemically to one another and which under application conditions undergo segregation into at least two microphase-separated regions, the microphase-separated regions having softening temperatures either from a first softening temperature range or from a second softening temperature range.

The term “microphase-separated” refers here to the formation of separated microphases, so that the different polymer blocks, for example, are present in different elongated microphase-separated regions (domains)—for instance, in the form of prolate, or uniaxially elongated structural elements (rodlet-shaped elements, for example) or oblate, or biaxially elongated (for example laminar) structural elements—or three-dimensionally cocontinuous microphase-separated regions, or may form a continuous matrix of one kind of polymer blocks with regions of another kind of polymer blocks dispersed therein.

The first softening temperature range here, as in the examples below, is a range of softening temperature which deviates from the second softening temperature range. Thus, if the second softening temperature range encompasses preferably low softening temperatures, the first softening temperature range encompasses high softening temperatures, or, vice versa, if the second softening temperature range encompasses high softening temperatures, the first softening temperature range encompasses low softening temperatures. Low softening temperatures here, as in the examples below, mean softening temperatures of −125° C. to +20° C., more particularly softening temperatures of −100° C. to +20° C., preferably between −80° C. and +20° C. High softening temperatures here, as in the examples below, are softening temperatures of +25° C. to +160° C., more particularly softening temperatures of +60° C. to +140° C., preferably between +80° C. and +130° C.

For use in tacky heat-activable pressure-sensitive adhesive, use is made, for example, of diblock copolymers and triblock copolymers which are constructed in accordance with this stoichiometric formula with i=j=k=1 (for the two-block copolymers) and with i+j=3 (i, j>0) and k=1 (for the triblock copolymers).

As acrylate-containing block copolymers it is additionally possible to use polymers of the above type P(A)-P(B) whose skeleton is composed of two interlinked polymer blocks P(A) and P(B), it being possible for P(A) to be substituted by P(A/C) and/or for P(B) to be substituted by P(B/D). P(A) and P(B) identify polymer blocks obtained by polymerizing at least one monomer of type A or by polymerizing at least one monomer of type B, respectively. P(A/C) and P(B/D) identify copolymer blocks obtained by polymerizing at least one monomer of type A and at least one monomer of the further type C and, respectively, by polymerizing at least one monomer of type B and also at least one monomer of the further type D.

As block copolymers it is likewise possible to use block copolymers of the kind comprising two interlinked polymer blocks of the general type P(A)-P(B/D) in which each block copolymer is composed of a first polymer block P(A) and of a second copolymer block P(B/D) joined to it,
P(A) representing a polymer block obtained by polymerizing at least one monomer of type A, P(A) having a softening temperature from a first softening temperature range,
P(B/D) representing a copolymer block obtained by copolymerizing at least one monomer of type B and at least one monomer of type D, P(B/D) having a softening temperature from a second softening temperature range, with monomers of type D possessing at least one functional group for crosslinking that is substantially inert in a free-radical copolymerization reaction, and which is suitable for crosslinking the reactive resin with the block copolymer, and the
polymer blocks P(A) and P(B/D) are in microphase-separated form under application conditions, and so the polymer blocks P(A) and P(B/D) are not completely (homogeneously) miscible under application conditions.

The crosslinking action of the copolymer block P(B/D) can alternatively be brought about through the formation of bonds between the individual block copolymer macromolecules P(A)-P(B/D), with the crosslinking groups of the comonomers of type D of one block copolymer macromolecule reacting with at least one further block copolymer macromolecule. Particularly suitable functional groups of the comonomers of type D include epoxide groups.

Monomers of type A for the polymer block P(A) are selected such that the resulting polymer blocks P(A) are capable of forming a two-phase microphase-separated structure with the copolymer blocks P(B/D). The fraction of the polymer blocks P(B/D) is typically between about 20% and 95% by weight, preferably between 25% and 80% by weight of the total block copolymer.

Moreover, the weight fraction of the comonomers of type D in the copolymer block P(B/D) in relation to the weight fraction of the monomers of type B is between 0% and 50%, typically between 0.5% and 30%, preferably between 1.0% and 20%.

Furthermore the block copolymers may comprise those of the general type P(A/C)-P(B/D) and also those of the general type P(A)-P(B), where
P(A) and P(B) each represent a polymer block obtained by polymerizing at least one monomer of type A or of type B respectively, P(A) having a softening temperature from a first softening temperature range and P(B) having a softening temperature from a second softening temperature range,
P(A/C) and P(B/D) each represent a copolymer block obtained by copolymerizing at least one monomer of type A with at least one monomer of type C or at least one monomer of type B with at least one monomer of type D, respectively, P(A/C) having a softening temperature from a first softening temperature range and P(B/D) having a softening temperature from a second softening temperature range, with monomers of type C and D possessing at least one functional group which behaves substantially inertly in a free-radical polymerization reaction and which is suitable for the reaction with the reactive resins, and
polymer blocks P(A) and P(B) or polymer blocks P(A/C) und P(B/D) are in microphase-separated form under application conditions, and the corresponding polymer blocks are therefore not completely (homogeneously) miscible under application conditions.

The fraction of the polymer blocks P(B) and P(B/D) is typically between about 20% and 95% by weight, preferably between 25% and 80% by weight, of the total block copolymer, so that the polymer blocks P(B) and P(B/D), respectively, are able to form elongated microphase-separated regions, in the form for instance of prolate (for example rodlet-shaped) or oblate (for example flat-shaped) structural elements, three-dimensionally cocontinuous microphase-separated regions or a continuous matrix with regions dispersed in it of the polymer blocks P(A) or P(A/C).

In the copolymer block P(B/D) the ratio of the weight fraction of the comonomers of type D to the weight fraction of the comonomers of type B adopts a value between 0% and 50%, typically a value between 0.5% and 30%, preferably between 1% and 20%. The same applies to the weight fraction of the comonomers of type C in the copolymer block P(A/C) in relation to the weight fraction of the comonomers of type A in the copolymer block P(A/C).

The block copolymers may likewise encompass those of general structure Z-P(A)-P(B)-Z′, Z-P(A/C)—P(B)-Z′ or Z-P(A/C)—P(B/D)-Z′, where Z and Z′ represent further polymer blocks or else functional groups; Z and Z′ here may be identical or different.

The block copolymers may likewise be triblock copolymers of the kind P(A)-P(B)—P(A′), it being possible for P(A) to be substituted by P(A/C) and/or for P(B) to be substituted by P(B/D) and/or for P(A′) to be substituted by P(A′/C′). P(A), P(B) and P(A′) identify polymer blocks obtained by polymerizing at least one monomer of type A or B or A′, respectively. P(A/C), P(B/D) and P(A′/C′) identify copolymer blocks obtained by copolymerizing at least one monomer of type A and one monomer of type C, or at least one monomer of type B and one monomer of type D, or at least one monomer of type A′ and one monomer of type C′, respectively.

With the aforementioned block copolymers, in structural terms, both symmetrical and asymmetrical constructions are possible, the term construction referring to geometrical parameters (for example block lengths, block molar-mass distribution or block-length distribution) and also to the chemical construction of the polymer blocks. In the text below it is assumed that it is always possible to use both kinds of polymers in accordance with the invention, both symmetrical and asymmetrical. In order to keep the description readable, however, reference is not made separately to block copolymers of asymmetric construction that are likewise possible.

The block copolymers may be those of the general type P(A)-P(B/D)-P(A), in which each block copolymer is composed of a central copolymer block P(B/D) and two polymer blocks P(A) attached to it,
P(B/D) representing a copolymer obtained by copolymerizing at least one monomer of type B and at least one monomer of type D, with P(B/D) having a softening temperature from a first softening temperature range, and the comonomer of type D possessing at least one functional group which behaves substantially inertly in a free-radical polymerization reaction, and which is suitable for reaction with the reactive resin of the block copolymer,
P(A) representing a polymer block obtained by polymerizing at least one monomer of type A, P(A) having a softening temperature from a second softening temperature range, and the
polymer blocks P(A) and P(B/D) being in microphase-separated form under application conditions, so that the polymer blocks P(A) and the polymer blocks P(B/D) are not completely (homogeneously) miscible under application conditions.

Furthermore, the crosslinking action of the copolymer block P(B/D) may be induced by formation of bonds between the individual block copolymer macromolecules P(A)-P(B/D)-P(A), the crosslinking groups of the comonomers of type D of one block copolymer macromolecule reacting with at least one further block copolymer macromolecule. Particularly suitable examples of functional groups of the comonomers of type D are epoxide groups.

Monomers of type A for the polymer blocks P(A) are selected such that the resulting polymer blocks P(A) are capable of forming a two-phase microphase-separated structure with the copolymer blocks P(B/D). The fraction of the polymer blocks P(A) is preferably between 5% and 95% by weight, with particular preference between 10% and 90% by weight of the total block copolymer.

It is further the case for the polymer block P(B/D) that the weight fraction of the monomers of type D in relation to the weight fraction of the monomers of type B is between 0% and 50%, typically between 0.5% and 30%, preferably between 1% and 20%.

Additionally as block copolymers it is possible to use those of the general type P(B/D)-P(A)-P(B/D), each block copolymer comprising a central polymer block P(A) and two polymer blocks P(B/D) attached to it on either side,
P(B/D) representing a copolymer obtained by copolymerizing at least one monomer of type B and at least one monomer of type D, with P(B/D) having a softening temperature from a first softening temperature range,
P(A) identifying a polymer obtained by polymerizing at least one monomer of type A, P(A) having a softening temperature from a second softening temperature range, and the
polymer blocks P(A) and P(B/D) being in microphase-separated form, so that the blocks P(B/D) and P(A) are not completely (homogeneously) miscible under application conditions.

Preferably the monomers of type D contain at least one functional group which behaves substantially inertly in a free-radical polymerization and which serves for reaction with the reactive resin.

The fraction of the polymer blocks P(A) is preferably between 5% and 95% by weight, in particular between 10% and 90% by weight of the total block copolymer.

Furthermore, the weight fraction of the comonomers of type D in the copolymer block P(B/D) in relation to the weight fraction of the comonomers of type B in the copolymer block P(B/D) is between 0% and 50%, typically between 0.5% and 30%, preferably between 1% and 20%.

As block copolymers it is possible, moreover, to use those of the general type P(B/D)-P(A/C)—P(B/D), with each block copolymer comprising a central polymer block P(A/C) and two polymer blocks P(B/D) attached to it on either side,
P(B/D) and P(A/C) each representing a copolymer block obtained by copolymerizing at least one monomer of type A or B and at least one monomer of type C or D respectively, P(B/D) having a softening temperature from a first softening temperature range and P(A/C) having a softening temperature from a second softening temperature range, and the monomers C and D possessing at least one functional group which behaves substantially inertly in a free-radical polymerization reaction, and which is suitable in particular for reaction with the reactive resin, and the
polymer blocks P(A/C) and polymer blocks P(B/D) being in microphase-separated form, so that the blocks P(B/D) and P(A/C) are not completely (homogeneously) miscible under application conditions.

The monomers of type C and D preferably contain at least one functional group which behaves substantially inertly in a free-radical polymerization reaction and serves for reaction with the reactive resin. With particular advantage this reaction takes place with the participation of epoxide groups.

The fraction of the polymer blocks P(A/C) is typically between 5% and 95% by weight, in particular between 10% and 90% by weight of the total block copolymer.

Furthermore, the weight fraction of the comonomers of type D in the copolymer block P(B/D) in relation to the weight fraction of the comonomers of type B in the copolymer block P(B/D) is between 0% and 50%, typically between 0.5% and 30%, preferably between 1% and 20%. The same applies to the ratio of the weight fractions of the comonomers C and A in the copolymer block P(A/C).

As block copolymers it is also possible, however, to employ those of the general structure Z-P(A)-P(B)—P(A′)-Z′, where Z and Z′ may comprise further polymer blocks or else functional groups; Z and Z′ here may be identical or different from one another. P(A), P(B) and P(A′) may optionally and independently of one another also take the form of copolymer blocks P(A/C), P(B/D) and P(A′/C′), respectively. In specific cases it is possible for individual blocks to be omitted.

Likewise suitable as block copolymers are linear and star-shaped multi-block copolymers of the construction
(I) [P(E₁)]-[P(E₂)]-[P(E₃)]- . . . -[P(Eₘ)] with m >3
(II) {[P(E₁)]_{δ}-[P(E₂)]_{δ}-[P(E₃)]_{δ}- . . . -[P(Eₙ)]_{δ}}ₓX with x>2, n>1, δ=0, 1,
   where
   (I) identifies a linear multi-block copolymer constructed from m polymer blocks P(E),
   (II) identifies a star-shaped multi-block copolymer containing a polyfunctional crosslinking region X in which x polymer arms are joined chemically to one another and in which each polymer arm is composed of at least one polymer block P(E), the serial number δ indicating that the x polymer arms joined to one another by chemical bonding in the polyfunctional crosslinking region may each have a different number of polymer blocks P(E),
   P(E) can in each case be substituted by P(E/F), with P(E) representing polymer blocks obtained by polymerizing at least one monomer of type E, and P(E/F) representing copolymer blocks obtained by copolymerizing at least one monomer of type E and at least one monomer of type F,
   the individual P(E) have a softening temperature from a first softening temperature range or from a second softening temperature range, with monomers of type C possessing at least one functional group which behaves substantially inertly in a free-radical copolymerization reaction, and which is suitable for reaction with the reactive resin, and the
   polymers are in microphase-separated form under application conditions, so that the individual polymer blocks are not completely (homogeneously) miscible under application conditions.

The acrylate block copolymers typically have one or more of the following three criteria:
a molar mass Mₙ of less than 10 000 000 g/mol, preferably a molar mass from a range from 30 000 g/mol and 1 000 000 g/mol,
a polydispersity D=M_{w}/Mₙ of less than 5, preferably of less than 3, or
one or more graft-attached side chains.

The monomers A for the polymer blocks P(A) and/or the copolymer blocks P(A/C), and the monomers B for the polymer blocks P(B) and/or the copolymer blocks P(B/D) and E for the polymer blocks P(E) and/or the copolymer blocks P(E/F) of the block copolymer used in accordance with the invention, are preferably chosen such that the blocks interlinked in the block copolymer are not completely (homogeneously) miscible with one another and, consequently, form a two-phase structure. This structure includes domains composed of miscible block segments (including whole blocks in the ideal case) of different (and possibly also identical) chains. Prerequisites for miscibility are a chemically similar construction of these block segments or blocks and block lengths adapted to one another. The domains adopt a particular shape and superstructure depending on the volume fraction of the phase within the system as a whole. Depending on the choice of monomers used it is possible for the domains to differ in their softening/glass transition temperatures, their hardness and/or their polarity.

The monomers employed in the polymer blocks P(A), P(B) and P(E) and in the copolymer blocks P(A/C), P(B/D) and P(E/F) are taken from the same monomer pool, which is described below.

For heat-activable adhesives it is advantageous to use acrylic monomers or vinyl monomers, more preferably those monomers which lower the softening/glass transition temperature of the copolymer block P(A/C)—also in combination with monomer C—or of the copolymer block P(B/D)—also in combination with monomer D—or of the copolymer block P(E/F)—also in combination with monomer F—to below 20° C.

When selecting the monomers for the heat-activable adhesives great advantage attaches to using one or more compounds which can be described by the following general formula

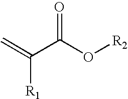

In this formula R₁=H or CH₃ and R₂ is selected from the group consisting of branched and unbranched, saturated alkyl groups having 1 to 20 carbon atoms.

Acrylic monomers which are used with preference for the heat-activable adhesive as monomers A, B, or E include acrylic and methacrylic esters with alkyl groups consisting of 1 to 18 C atoms, preferably 4 to 9 C atoms. Specific examples, without wishing to be restricted by this enumeration, are methyl acrylate, ethyl acrylate, n-butyl acrylate, n-pentyl acrylate, n-hexyl acrylate, n-heptyl acrylate, n-octyl acrylate, n-nonyl acrylate, lauryl acrylate, stearyl acrylate and their branched isomers, such as 2-ethylhexyl acrylate, isobutyl acrylate and isooctyl acrylate, for example.

Further monomers that can be used for the polymer blocks P(A), P(B) and P(E) and the copolymer blocks P(A/C), P(B/D) and P(E/F) are monofunctional acrylates and methacrylates of bridged cycloalkyl alcohols composed of at least 6 carbon atoms. The cycloalkyl alcohols may also be substituted. Specific examples are cyclohexyl methacrylate, isobornyl acrylate, isobornyl methacrylate and 3,5-dimethyladamantyl acrylate.

Additionally use is made optionally, for the polymer blocks P(A), P(B) and P(E) and copolymer blocks P(A/C), P(B/D) and P(E/F), of vinyl monomers from the following groups:

vinyl esters, vinyl ethers, vinyl halides, vinylidene halides, vinyl compounds containing aromatic rings and heterocycles in α position.

Here again mention may be made non-exclusively of some examples, particularly vinyl acetate, vinylformamide, ethyl vinyl ether, vinyl chloride, vinylidene chloride and acrylonitrile.

In addition, optionally, use is made for the polymer blocks P(A), P(B), and P(E) and copolymer blocks P(A/C), P(B/D), and P(E/F), of vinyl monomers from the following groups:

acrylic acid, hydroxyethyl acrylate, hydroxypropyl acrylate, hydroxyethyl methacrylate, hydroxypropyl methacrylate, n-methylolacrylamide, acrylic acid, methacrylic acid, allyl alcohol, maleic anhydride, itaconic anhydride, itaconic acid, phenoxyethyl acrylate, phenoxyethyl methacrylate, 2-butoxyethyl methacrylate, 2-butoxyethyl acrylate, cyano-ethyl methacrylate, cyanoethyl acrylate, 6-hydroxyhexyl methacrylate, tetrahydrofurfuryl acrylate, and acrylamide.

Furthermore, optionally, for the polymer blocks P(A), P(B), and P(E) and for the copolymer blocks P(A/C), P(B/D), and P(E/F), vinyl monomers from the following groups are used:

N,N-dialkyl-substituted amides, such as N,N-dimethylacrylamide, N,N-dimethyl-methacrylamide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(butoxymethyl)methacrylamide, N-methylol-acrylamide, N-(ethoxymethyl)acrylamide, N-isopropylacrylamide; this listing should be considered as by way of example.

Furthermore, optionally, for the polymer blocks P(A), P(B), and P(E) and copolymer blocks P(A/C), P(B/D), and P(E/F), vinyl monomers are used from the following groups:

acrylic monomers, methacrylic monomers or vinyl monomers which increase the softening/glass transition temperature of the copolymer block P(A/C)—also in combination with monomer A—or of the copolymer block P(B/D)—also in combination with monomer B—or of the copolymer block P(E/F)—also in combination with monomer E.

Examples of corresponding monomers are hence also methyl methacrylate, cyclohexyl methacrylate, tert-butyl acrylate, isobornyl methacrylate, benzyl acrylate, benzyl methacrylate, benzoin acrylate, benzoin methacrylate, acrylated benzophenone, methacrylated benzophenone, phenyl acrylate, phenyl methacrylate, tert-butylphenyl acrylate, tert-butylphenyl methacrylate, 4-biphenylyl acrylate, 2-naphthyl acrylate, and 2-naphthyl methacrylate or styrene, this listing not being conclusive.

Furthermore, optionally, use is made, for the polymer blocks P(A), P(B), and P(E) and copolymer blocks P(A/C), P(B/D), and P(E/F) of vinyl monomers from the following groups:

vinylaromatic monomers, which may also be alkylated, functionalized or contain hetero-atoms, and which preferably possess aromatic nuclei of C₄ to C₁₈, including for instance α-methylstyrene, 4-vinylbenzoic acid, the sodium salt of 4-vinyl-benzenesulphonic acid, 4-vinylbenzyl alcohol, 2-vinylnaphthalene, 4-vinylphenylboronic acid, 4-vinylpyridine, phenyl vinylsulfonate, 3,4-dimethoxystyrene, vinyl benzotrifluoride, p-methoxystyrene, 4-vinylanisole, 9-vinylanthracene, 1-vinylimidazole, 4-ethoxystyrene, N-vinylphthalimide, this listing making no claim to completeness.

When synthesizing the block copolymers it is necessary to ensure when selecting the respective monomer combinations that the polymer blocks prepared from the monomers used are not completely miscible with one another.

Use may also be made as monomers C, D and F for the copolymer blocks P(A/C), P(B/D) and P(E/F) of vinyl compounds, acrylates and/or methacrylates which carry functional groups such as epoxide groups or phenol groups.

Also possibly used as monomers C, D and F for the copolymer blocks P(A/C), P(B/D) and/or P(E/F) are one or more monomers having at least one functional group which can be described by the following general formula:

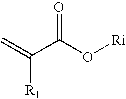

In this formula R₁ is H or CH₃ and Rᵢ is H or an organic radical containing at least one functional group and containing between 1 and 30 carbon atoms. Thus as monomer containing vinyl groups one can use, for example, glycidyl methacrylate.

The monomer B from polymer block P(B) is preferably structurally different from the monomer A from polymer block P(A). Where two or more monomers are used within one polymer block, i.e. within one polymer block P(A) or polymer block P(B), monomer A or monomer B respectively may also denote different individual monomers within the respective polymer block P(A) or P(B). Instead, the difference between the monomers A and B may also refer to the number within the polymer block P(A) or P(B), respectively.

The polymerization for preparing the block copolymers can be carried out by typical methods or in modification of typical methods, in particular by means of conventional free-radical addition polymerization and/or by means of controlled free-radical addition polymerization; the latter is characterized by the presence of suitable control reagents.

To prepare the block copolymers it is possible in principle to use all polymerizations which proceed in accordance with a controlled or living mechanism, including combinations of different controlled polymerization methods. Without possessing any claim to completeness, mention may be made here, by way of example, besides anionic polymerizations, of the ATRP, nitroxide/TEMPO-controlled polymerization or RAFT process methods already mentioned above, which in particular allow control over the block lengths, polymer architecture and possibly even the tacticity of the polymer chain.

All in all it is possible to vary the compositions for the heat-activable adhesives within wide ranges, by changing the nature and proportion of the starting materials. It is also possible to exert targeted control over further product properties, such as colour, thermal conductivity or electrical conductivity, for example, through the addition of auxiliaries such as dyes, mineral or organic fillers, carbon powders and/or metal powders.

As will be appreciated, all of the heat-activable adhesives described above may also include further ingredients and/or auxiliaries, insofar as this is desired or even necessary for the targeted control of certain properties of the adhesive or of the bond, in accordance with the particular end use. Particularly in combination with reactive systems, a multiplicity of other additives are frequently used, such as resins, filling materials, catalysts, ageing inhibitors and the like, of which some have already been nominated above as a formulating ingredient.

The adhesives depicted above, and also further adhesives not described in detail here, but known to the skilled worker readily as heat-activable adhesives, are applied in conventional processes to the carrier film, in accordance with the invention. In accordance with the respective application methods, the adhesive can be coated from solution. Blending of the base polymer with further ingredients, such as modifier resins or auxiliaries, can be done using any known mixing or stirring techniques. Thus, for example, it is possible for static or dynamic mixing assemblies to be employed in order to produce a homogeneous mixture. Alternatively, blending of the base polymer with reactive resins can be carried out in the melt. For that purpose, kneading compounders or twin-screw extruders can be used. Blending is preferably done hot, although the mixing temperature should be significantly lower than the activation temperature for reactive operations in the mixing assembly, such as for reaction of the epoxy resins.

For application of the adhesive from the melt, the solvent can be stripped off in a concentrating extruder under reduced pressure, for which purpose it is possible for example to use single-screw or twin-screw extruders, which preferably distil off the solvent in the same vacuum stage or in different vacuum stages, and which possess a feed preheater. The fraction of residual solvent is advantageously less than 1% by weight or even less than 0.5% by weight.

For optional crosslinking of the adhesives it is possible to add any suitable initiators and/or crosslinkers to them. Thus for subsequent crosslinking during irradiation with UV light it is possible for the heat-activable adhesives to contain, for example, UV-absorbing photoinitiators. Examples of suitable photoinitiators are benzoin ethers such as benzoin methyl ether or benzoin isopropyl ether, substituted acetophenones such as dimethoxyhydroxyacetophenone or 2,2-diethoxyacetophenone (available as Irgacure 651® from Ciba Geigy), 2,2-dimethoxy-2-phenyl-1-phenylethanone, substituted α-ketols such as 2-methoxy-2-hydroxypropiophenone, aromatic sulphonyl chlorides such as 2-naphthylsulphonyl chloride, and photoactive oximes such as 1-phenyl-1,2-propanedione-2-(O-ethoxycarbonyl)oxime.

The photoinitiators which can be used and other initiators of the Norrish I or Norrish II type may be substituted and may in this case have any desired suitable radicals, examples being benzophenone, acetophenone, benzil, benzoin, hydroxyalkylphenone, phenyl cyclohexyl ketone, anthraquinone, trimethylbenzoylphosphine oxide, methylthiophenyl morpholine ketone, aminoketone, azobenzoin, thioxanthone, hexaarylbisimidazole, triazine or fluorenone radicals, which radicals of course may be substituted in turn, such as by one or more halogen atoms, alkyloxy groups, amino groups and/or hydroxyl groups. A representative overview is offered by Fouassier in “Photoinitiation, Photopolymerization and Photocuring: Fundamentals and Applications” (Hanser-Verlag, Munich 1995) and—by way of supplementation—by Carroy et al. in “Chemistry and Technology of UV and EB Formulation for Coatings, Inks and Paints” (Oldring (ed.), 1994, SITA, London).

The heat-activable adhesives can of course also be crosslinked with electron beams. Typical irradiation equipment used possibly for that purpose includes linear cathode systems, scanner systems or segmented cathode systems in the case of electron beam accelerators. A detailed description of the state of the art and also of the most important process parameters is found in Skelhorne (“Electron Beam Processing”) in “Chemistry and Technology of UV and EB formulation for Coatings, Inks and Paints” (Vol. 1, 1991, SITA, London). Typical acceleration voltages are situated in the range between 50 kV and 500 kV, in particular 80 kV and 300 kV, with a scatter dose from a range from 5 kGy to 150 kGy, in particular from 20 kGy to 100 kGy.

For producing the heat-activatedly bondable 2D diecutting element, to start with, preferably, a first adhesive coating is applied in a first coating step to a release paper. If coating here takes place from solution, the adhesive coating after this first coating step may be free from solvent remaining in the adhesive, by means, for instance, of evaporation of the solvent in a drying tunnel or in a drying room. Subsequently the microperforated carrier film is laminated onto this first adhesive coating applied to the release paper, by way of a laminating roll. This is done advantageously under pressure, instead of or in addition to which the system may be heated. Temperature and applied pressure of the laminating roll may be varied in accordance with the activation temperature and flow behaviour of the adhesive used.

Subsequently, in a second coating step, the second adhesive coating can be applied directly to the second side of the carrier film. Alternatively the heat-activable adhesive can also be laminated onto the second side of the carrier film.

A 2D diecutting element obtained in this way typically has a thickness from a range from 5 to 300 μm, in particular from a range from 10 to 50 μm.

After double-sided coating of the carrier film with the heat-activable adhesives, a diecut in the desired form is then punched from the resultant heat-activatedly bondable 2D diecutting element. This diecut is likewise heat-activatedly bondable.

Beforehand it is useful to coat the heat-activatedly bondable 2D diecutting element of the invention on one or both sides with a suitable release agent, such as a release paper, in order thus to prevent unwanted sticking of the adhesive surfaces of the diecut to other diecuts, to the cutting die, to the conveying apparatus and the like. For this purpose it is of course also possible to use the release paper described above, from the manufacture of the 2D diecutting element, if it has been left on the adhesive coating.

The shaping of the diecut then takes place in one cutting step. Diecutting in the present case means any shaping separation of different utility blanks in a shear cutting procedure, including penetration, blade cutting or scissor cutting operations. In particular this term describes the shaping of the sheetlike diecutting material or diecutting stock to be cut, i.e. the 2D diecutting element, in specific diecutting machines, for which typically cutting dies such as blade dies, plates, formes, rules and the like are employed. The residual diecutting material which remains in these procedures, the diecutting margin or diecutting matrix, is frequently discarded here as diecut waste.

Diecuts of this kind can be used as single-sidedly or double-sidedly adhesive, heat-activatedly bondable products, for the purpose, for instance, of adhesive bonding in the household and in industry, more particularly in automotive engineering, the electrical and electronics industries, for assembly purposes, such as when mounting signs, badges, film keyboards and the like, in the medical sector, for plasters or wound coverings, for example, to name but a few of the application examples.

For the purpose of illustrating the invention, a number of advantageous embodiments of the invention will be explained, purely by way of example and without wishing, through the choice of the examples, to restrict the invention to these versions. This is depicted illustratively with reference to the figures.

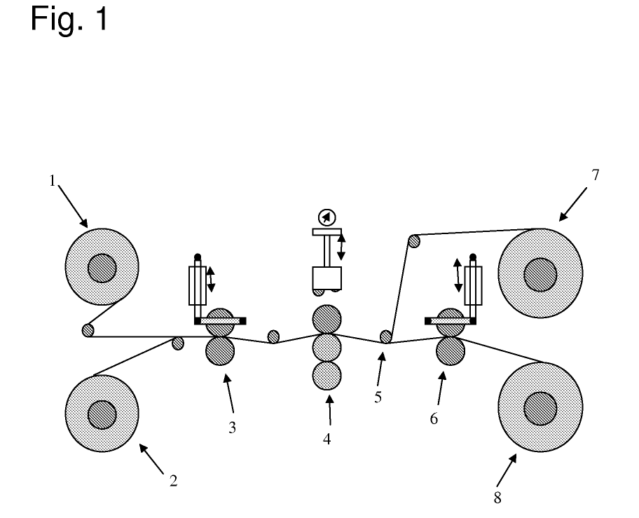

FIG. 1 shows a schematic representation of a combined laminating and rotary diecutting unit,

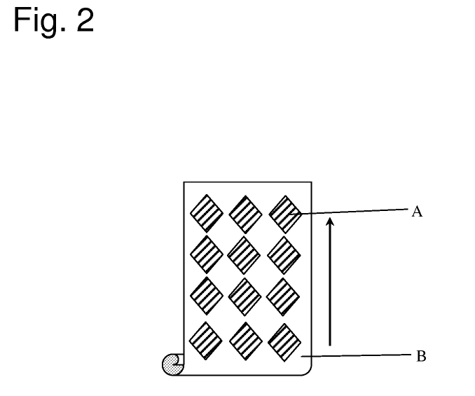

FIG. 2 shows an arrangement of diamond-shaped diecuts on a release paper,

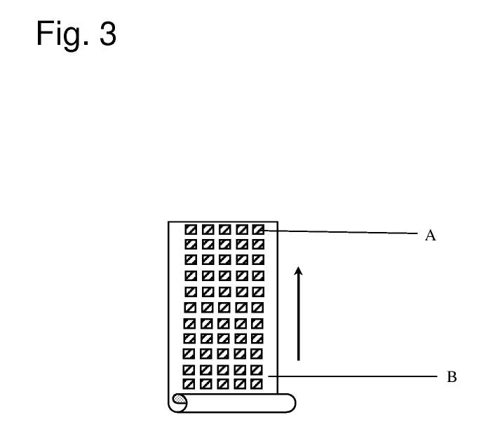

FIG. 3 shows an arrangement of rectangular diecuts on a release paper, and

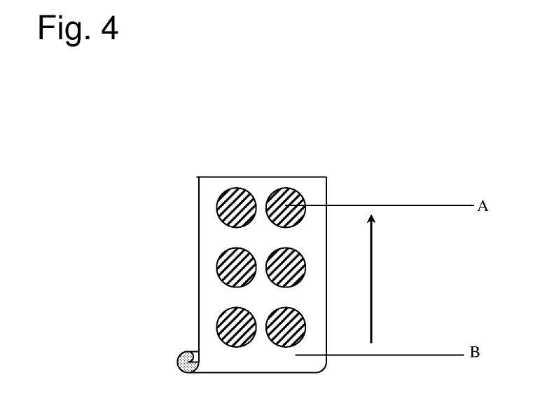

FIG. 4 shows an arrangement of circular diecuts on a release paper.

To produce a heat-activatedly bondable 2D diecutting element, a polyethylene terephthalate film having a thickness of 12 μm was used, and was provided with perforation in a hot needle process. The average internal diameter of the circular holes produced in this process, with a density per unit area of 9 mm⁻², was 200 μm. After the hot needling, the polyethylene terephthalate film was provided with Saran primer on both sides.

After that, the polyethylene terephthalate film microperforated in this way was coated on both sides with a heat-activable adhesive, as the adhesive coating. For this purpose, a heat-activatedly bondable adhesive transfer tape, based on a nitrile rubber and a phenolic resin on a siliconized release paper (tesa HAF 8402 from tesa AG), was applied to the polyethylene terephthalate carrier film by means of a roll laminator at a temperature of 110® C. with an applied pressure of 4 bar and with a web speed of 2.5 m/min. The release paper material used was composed in this case of a polyolefinically coated paper, in other words a paper with a coating based on polyethylene, which was siliconized on both sides and had a thickness of 120 μm (referred to below as “original release material”).

To investigate the diecuttability of this 2D diecutting element, it was subsequently subjected to different diecutting procedures, and the quality both of the diecuts and of the detachment properties was investigated.

Coating and diecutting were carried out here in a combined laminating/rotary diecutting unit. The diecutting machine used was a flat-bed diecutting machine from Melzer Maschinenbau GmbH. The 2D diecutting element was supplied in the form of rolls with a width of 130 mm. The release materials laminated on had a roll width of 145 mm.

The 2D diecutting element, coated on both sides with heat-activable adhesive and on one side with release paper, was unwound from the roll. Laminated to the side of the 2D diecutting element coated with exposed adhesive, from above, was a second siliconized release material. The second release material (auxiliary release material) used was a single-sidedly siliconized glassine release paper.

Thereafter the 2D diecutting element, now coated on both sides with heat-actiavable adhesive and release paper, was punched in a “kiss-cut” procedure, in which the 2D diecutting element is diecut without severing the olefinic original release material. The average diecutting speed was 2200 strokes/h and was varied as and when required.

Finally, the residue of the auxiliary release material left after diecutting, with adhesives and the remnants of the carrier film adhering to it, was taken off on a semi-continuous basis as diecutting waste (diecutting matrix). The distance between the diecutting unit and the diecutting waste remover was 310 mm. Removal was carried out by a blade with a take-off angle of 135°.

In deviation from this, at a diecutting speed of 2500 strokes/h, the diecutting waste was not taken off continuously in the diecutting unit but was instead only taken off later, manually, after a rest time of two weeks, in order to investigate the flow-on behaviour of the adhesives.

As an alternative to the flat-bed diecutting unit, a rotary cutting machine from SMO was used. The construction of the combined laminating/rotary diecutting unit is shown schematically in FIG. 1. The second siliconized auxiliary release material was unwound from the stock roll 1 and laminated from above onto the uncovered side of the adhesive of the 2D diecutting element, onto the 2D diecutting element coated on both sides with heat-activable adhesive and on one side with release paper, from stock roll 2, in the laminating unit 3. The 2D diecutting element had a roll width of 130 mm. The release materials laminated on had a roll width of 145 mm. The auxiliary release material used was a single-sidedly siliconized glassine release paper.

In the rotary diecutting cylinder unit 4, the 2D diecutting element, now covered on both sides with release paper, was punched in a “kiss cut” procedure, in which the 2D diecutting element was punched out on the original release material. The average web speed in this procedure was 18 m/min. The diecutting formes used were in each case diecutting cylinders from the company RotoMetrics International Ltd.

Finally, the diecutting waste was taken off continuously at an angle of approximately 80° in the take-off unit 5 and was rolled onto the receiving drum 7. Following passage through the tension unit 6, the finished diecut product—the diecuts arranged on the original release material—was rolled up on the receiving drum 8.

Virtually all of the diecut shapes investigated were produced successfully both in the flat-bed process and in the rotary diecutting process. The cutting dies were designed so that identical end products were produced by both processes.

FIG. 2 shows diamond-shaped diecuts on a siliconized carrier release material B (original release material), which are lined with siliconized release material A (auxiliary release material). The diecuts have no diecutting wastes such as connecting bridges anymore. The dimensions of the diecuts are 14 mm from tip to tip.

The diecuts obtained in this way were diecuttable with high efficiency and possess outstanding diecuttability. Moreover, as a result of the perforated carrier film, the diecuts possess good dimensional stability.

FIG. 3 shows square diecuts on a siliconized carrier release material B (original release material), lined with siliconized release material A (auxiliary release material). The diecuts no longer have any diecutting waste. The length of the side edges of the diecuts is 5 mm.

These diecuts as well can be diecut with high efficiency and possess outstanding diecuttability. The detachment of the diecuts from the original release material within the dispensing operation was likewise unimpaired.

FIG. 4 shows circular diecuts on a siliconized carrier release material B (original release material), the diecuts having been lined with siliconized release material A (auxiliary release material). The diecuts no longer have any diecutting waste. The circular diameter of the diecuts is 8 mm.

In principle the manufacture of circular diecuts is fairly difficult to implement. Here as well it was possible to detach the diecutting waste from the diecut product without problems. Manual detachment after a rest time of two weeks was likewise possible with no problems.

The diecuts produced in this way were heat-activatedly bondable and, following detachment of the uncut original release material and/or detachment of the forme-cut auxiliary release material, were amenable to adhesive bonding at a bonding temperature of 120° C.

1. Heat-activatedly bondable, substantially two-dimensional (“2D”) diecutting element having a carrier, a first adhesive coating and a second adhesive coating,
the carrier taking the form of a carrier film having a first side and a second side,
the first adhesive coating being disposed on the first side of the carrier film and comprising at least one heat-activable adhesive,
and the second adhesive coating being disposed on the second side of the carrier film and comprising at least one heat-activable adhesive, wherein
the carrier film has a multiplicity of openings over its two-dimensional extent, said openings extending continuously through the carrier film from the first side of the carrier film through to the second side of the carrier film.

2. Heat-activatedly bondable 2D diecutting element according to claim 1, wherein the carrier film is a polyester film.

3. Heat-activatedly bondable 2D diecutting element according to claim 1, wherein the openings in the carrier film have internal diameters in the range of from 5 μm to 1 mm.

4. Heat-activatedly bondable 2D diecutting element according to claim 1, wherein the openings in the carrier film have a density per unit area of more than 1 mm⁻².

5. Heat-activatedly bondable 2D diecutting element according to claim 1, wherein the openings are in the form of round holes.

6. Heat-activatedly bondable 2D diecutting element according to claim 1, wherein at least one of the two heat-activable adhesives, the heat-activable adhesive of the first adhesive coating or the heat-activable adhesive of the second adhesive coating, comprises a thermoplastic base polymer.

7. Heat-activatedly bondable 2D diecutting element according to claim 1, wherein at least one of the two heat-activable adhesives, the heat-activable adhesive of the first adhesive coating or the heat-activable adhesive of the second adhesive coating, comprises
an elastomeric base polymer and
a modifier resin,
the modifier resin comprising a tackifier resin and/or a reactive resin.

8. Heat-activatedly bondable 2D diecutting element according to claim 1, wherein at least one of the two heat-activable adhesives, the heat-activable adhesive of the first adhesive coating or the heat-activable adhesive of the second adhesive coating, comprises
50 to 95% by weight of a bondable polymer and
5 to 50% by weight of an epoxy resin or mixture of two or more epoxy resins,
the bondable polymer comprising
40 to 94% by weight of acrylic acid compounds and/or methacrylic acid compounds of the formula CH₂═CH(R¹)(COOR²), R¹ representing a radical selected from the group consisting of H and CH₃, and R² representing a radical selected from the group consisting of H and alkyl chains having 1 to 30 carbon atoms,
5 to 30% by weight of a first copolymerizable vinyl monomer which has at least one carboxylic acid group and/or sulphonic acid group and/or phosphonic acid group,
1 to 10% by weight of a second copolymerizable vinyl monomer which has at least one epoxide group or one acid anhydride function and
0 to 20% by weight of a third copolymerizable vinyl monomer which has at least one functional group which differs from the functional group of the first copolymerizable vinyl monomer and from the functional group of the second copolymerizable vinyl monomer.

9. Heat-activatedly bondable 2D diecutting element according to claim 1, wherein at least one of the two heat-activable adhesives, the heat-activable adhesive of the first adhesive coating and the heat-activable adhesive of the second adhesive coating, comprises
40 to 98% by weight of acrylate-containing block copolymer,
2 to 50% by weight of one or more tackifying epoxy resins and/or novolak resins and/or phenolic resins and
0 to 1 0% by weight of curing agents for crosslinking the epoxy resins and/or novolak resins and/or phenolic resins.

10. A heat-activatedly bondable diecut cut from a heat-activatedly bondable 2D diecutting element according to claim 1.

11. Process for producing a heat-activatedly bondable 2D diecutting element of claim 1, comprising
coating the first side of the carrier film provided two-dimensionally with a multiplicity of continuous openings with the first adhesive coating of at least one heat-activable adhesive and
coating the second side of the carrier film provided two-dimensionally with a multiplicity of continuous openings with a second adhesive coating of at least one heat-activable adhesive.

12. Process for producing a diecut of claim 10, comprising
coating at least one side of the heat-activatedly bondable 2D diecutting element with a two-dimensional release agent,
diecutting the 2D diecutting element coated at least on one side with the two-dimensional release agent into a desired shape.

13. The diecutting element of claim 2, wherein said polyester film is a polyethylene terephthalate film or a polyethylene naphthalate film.
